(19) United States
(12) Patent Application Publication
(10) Pub. No.: US 2010/0226437 A1
(43) Pub. Date: Sep. 9, 2010

(54) REDUCED-RESOLUTION DECODING OF AVC BIT STREAMS FOR TRANSCODING OR DISPLAY AT LOWER RESOLUTION

(75) Inventors: Mark A. Robertson, Cupertino, CA (US); Ming-Chang Liu, San Jose, CA (US)

Correspondence Address: HAVERSTOCK & OWENS LLP, 162 N WOLFE ROAD, SUNNYVALE, CA, 94086, US

(73) Assignees: SONY CORPORATION, A JAPANESE CORPORATION, Tokyo (JP); SONY ELECTRONICS INC., a corporation of the State of Delaware, Park Ridge, NJ (US)

(21) Appl. No.: 12/399,187

(22) Filed: Mar. 6, 2009

(51) Int. Cl. H04N 7/32; H04N 7/26

(52) U.S. Cl. 375/240.16; 375/240.12; 375/E07.123; 375/E07.243

(57) ABSTRACT

A method of and system for reducing complexity for transcoding Advanced Video Coding (AVC) videos is described herein. Transcoding from higher resolution signals to lower resolution signals or to signals for a lower resolution display is implemented. The complexity is reduced by decoding the AVC video at reduced horizontal and/or vertical resolution. This results in the reduction of computation cost for decoding and re-sampling the AVC video to lower resolution.

### FIELD OF THE INVENTION

The present invention relates to the field of video processing. More specifically, the present invention relates to reduced-resolution video decoding.

### BACKGROUND OF THE INVENTION

A video sequence consists of a number of pictures, usually called frames. Subsequent frames are very similar, thus containing a lot of redundancy from one frame to the next. Before being efficiently transmitted over a channel or stored in memory, video data is compressed to conserve both bandwidth and memory. The goal is to remove the redundancy to gain better compression ratios. A first video compression approach is to subtract a reference frame from a given frame to generate a relative difference. A compressed frame contains less information than the reference frame. The relative difference can be encoded at a lower bit-rate with the same quality. The decoder reconstructs the original frame by adding the relative difference to the reference frame.

A more sophisticated approach is to approximate the motion of the whole scene and the objects of a video sequence. The motion is described by parameters that are encoded in the bit-stream. Pixels of the predicted frame are approximated by appropriately translated pixels of the reference frame. This approach provides an improved predictive ability over a simple subtraction approach. However, the bit-rate occupied by the parameters of the motion model must not become too large.

In general, video compression is performed according to many standards, including one or more standards for audio and video compression from the Moving Picture Experts Group (MPEG), such as MPEG-1, MPEG-2, and MPEG-4. Additional enhancements have been made as part of the MPEG-4 part 10 standard, also referred to as H.264, or AVC (Advanced Video Coding). Under the MPEG standards, video data is first encoded (e.g. compressed) and then stored in an encoder buffer on an encoder side of a video system. Later, the encoded data is transmitted to a decoder side of the video system, where it is stored in a decoder buffer, before being decoded so that the corresponding pictures can be viewed.

MPEG is used for the generic coding of moving pictures and associated audio and creates a compressed video bit-stream made up of a series of three types of encoded data frames. The three types of data frames are an intra frame (called an I-frame or I-picture), a bi-directional predicted frame (called a B-frame or B-picture), and a forward predicted frame (called a P-frame or P-picture). These three types of frames can be arranged in a specified order called the GOP (Group Of Pictures) structure. I-frames contain all the information needed to reconstruct a picture. The I-frame is encoded as a normal image without motion compensation. On the other hand, P-frames use information from previous frames and B-frames use information from previous frames, a subsequent frame, or both to reconstruct a picture. Specifically, P-frames are predicted from a preceding I-frame or the immediately preceding P-frame.

Besides MPEG standards, JPEG is used for the generic coding of still pictures. Since the encoding of a still picture can be considered as the encoding of an I frame in video, no introduction of JPEG will be provided here. There are some other proprietary methods for image/video compression. Most of them adopt similar technologies as MPEG and JPEG. Basically, each picture is separated into one luminance (Y) and two chrominance channels (also called color difference signals Cb and Cr). Blocks of the luminance and chrominance arrays are organized into “macroblocks,” which are the basic unit of coding within a frame. Block based transformation and quantization of transform coefficients are used to achieve high compression efficiency.

Since quantization is a lossy process, the combination of block-based transform and quantization is able to generate perceptually annoying artifacts such as ringing artifacts and blocking artifacts. Since coding artifact reduction is fundamental to many image processing applications, it has been investigated for many years. Many post-processing methods have been proposed. In general, most methods focus on blocking artifacts reduction or ringing artifacts reduction. Although some methods show good results on selected applications, the quality is not high enough on new digital HDTV. As a result, either the artifacts are still visible or the texture detail is blurred.

### SUMMARY OF THE INVENTION

A method of and system for reducing complexity for transcoding Advanced Video Coding (AVC) videos is described herein. Transcoding from higher resolution signals to lower resolution signals or to signals for a lower resolution display is implemented. The complexity is reduced by decoding the AVC video at reduced horizontal and/or vertical resolution. This results in the reduction of computation cost for decoding and re-sampling the AVC video to lower resolution.

In one aspect, a method of decoding Advanced Video Coding video at a reduced resolution using a computing device comprises decoding I-pictures at full resolution, resampling the I-pictures horizontally and vertically, performing inter prediction for P-pictures at full resolution, resampling the P-pictures horizontally and vertically, performing inter prediction for B-pictures at reduced horizontal resolution, resampling the B-pictures vertically and outputting a reduced-resolution video. The resampling implements a resampling ratio selected from the group consisting of 2:1, 8:3 and 9:4. A linear phase filter is used for 2:1 horizontal resampling. Three separate filters are used for 8:3 horizontal resampling. A set of long-tap filters is used for 9:4 vertical resampling. Alternatively, a set of short-tap filters is used for 9:4 vertical resampling. Filters implementing the resampling ratios of 2:1, 8:3 and 9:4 have bandwidths of π/2, 3π/8 and 4π/9, respectively. The method further comprises resampling that maintains a phase that preserves right-most columns of macroblocks. The method further comprises implementing motion compensation at reduced resolution. Implementing motion compensation uses bi-linear interpolation filters. Alternatively, implementing motion compensation uses plurality-tap filters. The method further comprises implementing a modified inverse discrete cosine transform to produce reduced-resolution pixel values. The method further comprises pre-scaling during inverse quantization. The method further comprises decoding an intra-coded macroblock using spatial prediction pixels at full resolution. The method further comprises receiving a first video to be decoded. The first video is high definition and the reduced-resolution video is standard definition.

In another aspect, a system for decoding Advanced Video Coding video at a reduced resolution using a computing device comprises a decoding module for decoding I-pictures at full resolution, a resampling module operatively coupled to the decoding module, the resampling module configured for resampling the I-pictures, P-pictures and B-pictures and an inter prediction module operatively coupled to the resampling module, the inter prediction module configured for performing inter prediction for the P-pictures and the B-pictures, resulting in a reduced-resolution decoded video. The resampling module implements a resampling ratio selected from the group consisting of 2:1, 8:3 and 9:4. A linear phase filter is used for 2:1 horizontal resampling. Three separate filters are used for 8:3 horizontal resampling. A set of long-tap filters is used for 9:4 vertical resampling. Alternatively, a set of short-tap filters is used for 9:4 vertical resampling. Filters implementing the resampling ratios of 2:1, 8:3 and 9:4 have bandwidths of π/2, 3π/8 and 4π/9, respectively. The system further comprises a motion compensation module configured for implementing motion compensation at reduced resolution. The motion compensation module uses bi-linear interpolation filters. Alternatively, the motion compensation module uses plurality-tap filters. The system further comprises a modified inverse discrete cosine transform module to produce reduced-resolution pixel values. The system further comprises pre-scaling during inverse quantization. The system further comprises an intra prediction module for decoding an intra-coded macroblock using spatial prediction pixels at full resolution. The system further comprises a first video is received to be decoded. The first video is high definition and the reduced-resolution decoded video is standard definition.

In another aspect, a method of decoding Advanced Video Coding video at a reduced resolution using a computing device comprises decoding I-pictures at full resolution, resampling the I-pictures horizontally and vertically, performing inter prediction for P-pictures at reduced horizontal resolution, resampling the P-pictures vertically, performing inter prediction for B-pictures at reduced horizontal resolution and outputting a reduced-resolution video.

In another aspect, a method of decoding Advanced Video Coding video at a reduced resolution using a computing device comprises decoding I-pictures at full resolution, resampling the I-pictures horizontally and vertically, performing inter prediction for P-pictures at full resolution, resampling the P-pictures horizontally and vertically, performing inter prediction for B-pictures at reduced horizontal resolution and reduced vertical resolution, resampling the B-pictures vertically and outputting a reduced-resolution video.

### BRIEF DESCRIPTION OF THE DRAWINGS

FIG. 1 illustrates a block diagram of a first mode of decoding.

FIG. 2 illustrates a block diagram of a second mode of decoding.

FIG. 3 illustrates a block diagram of a third mode of decoding.

FIG. 4 illustrates an intra-coded macroblock with correct and incorrect phases.

FIG. 5 illustrates AVC blocks and MPEG-2 macroblocks.

FIG. 6 illustrates a flowchart of a method of reduced-resolution decoding.

FIG. 7 illustrates a block diagram of a decoder to implement the reduced-resolution decoding method.

### DETAILED DESCRIPTION OF THE PREFERRED EMBODIMENT

Reduced-resolution decoding of MPEG-4 or AVC (Advanced Video Coding) video is described herein. One application of reduced-resolution decoding is to decrease the complexity of AVC decoding as part of an overall transcoding from high-definition to standard-definition. Other applications include reduced-complexity decoding of high-resolution AVC video for display at lower resolutions, for example, for picture-in-picture on a television or display of recorded AVC content from a camcorder on the camcorder's low-resolution display. In some embodiments, transcoding a high-definition AVC sequence to a standard-definition MPEG-2 sequence is implemented. In some embodiments, reduced-resolution decoding is implemented in the horizontal dimension and/or the vertical dimension.

For the AVC decoder, complexity is reduced by directly decoding parts of the sequence at reduced resolution. This method includes several main advantages including, but not limited to, reducing the cost of decoding and reducing the cost of resampling to lower resolution.

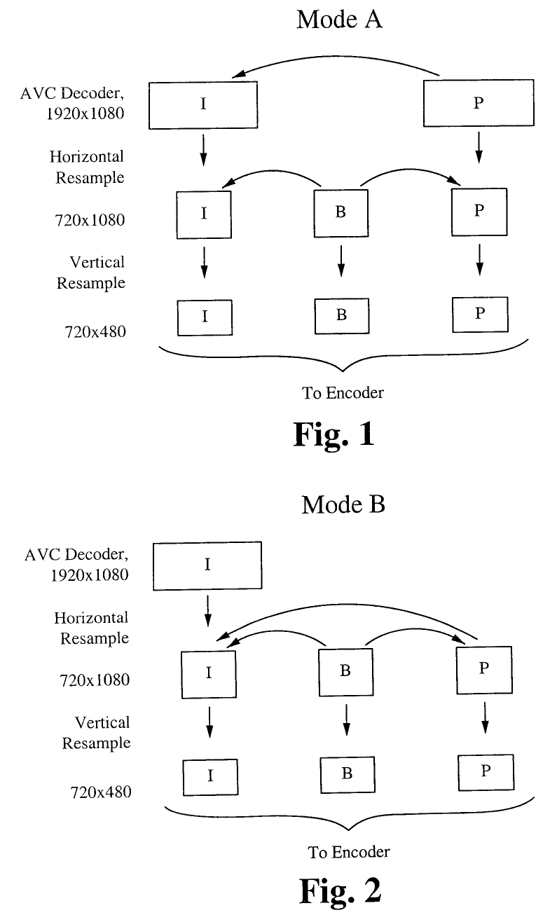

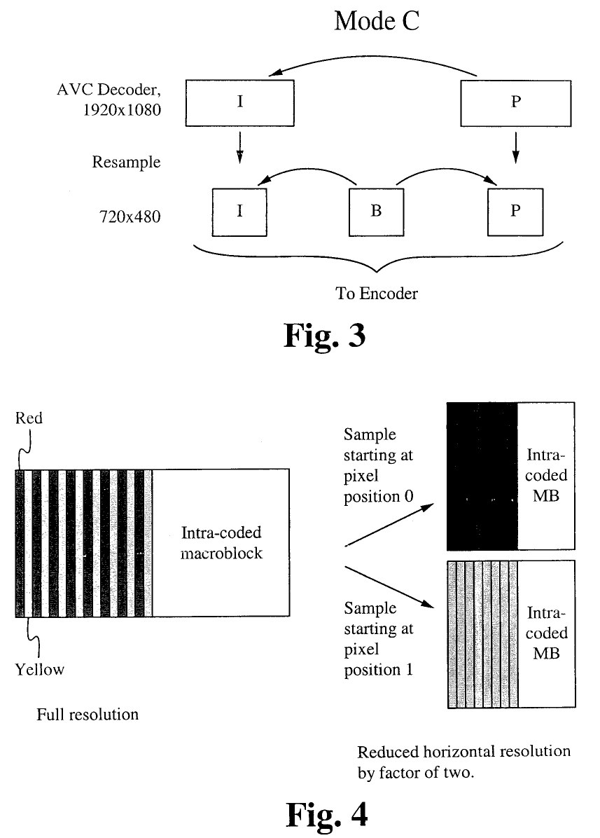

Three modes by which the transcoder is able to perform reduced-resolution decoding are described herein, referred to as Mode A, Mode B and Mode C. FIG. 1 illustrates the algorithm for Mode A. FIG. 2 illustrates the algorithm of Mode B. FIG. 3 illustrates the algorithm of Mode C.

In each of the three modes, I-pictures are decoded at full resolution. The I-pictures are resampled horizontally, and then resampled vertically to achieve the final resolution.

In Mode A, inter prediction for P-pictures is performed at full resolution as indicated by the top row of FIG. 1. The P-pictures are then resampled horizontally, and then resampled vertically to achieve the final resolution. Inter prediction for B-pictures is performed at reduced horizontal resolution, in the middle row of FIG. 1. The B-pictures are then resampled vertically to achieve the final resolution.

In Mode B, inter prediction for both P and B pictures is performed at reduced horizontal resolution, as indicated in the middle row of FIG. 2. The P and B pictures are then resampled vertically to achieve final vertical resolution.

In Mode C, inter prediction is just like Mode A, except that inter prediction for B-pictures is performed at reduced horizontal and reduced vertical resolution.

### Algorithm and Implementation Details

In some embodiments, reduced horizontal resolution motion compensation for a 2:1 resampling ratio is implemented. With such a ratio, video of 1440 pixels per line is able to be processed to give video of 720 pixels per line. In some embodiments, an 8:3 ratio is used for 1920 pixels per line.

### Resampling Filters

For all three Modes A, B and C, some pictures are spatially resampled. For the 2:1 horizontal resampling, the following linear phase filter is used:
{−3, 0, 35, 64, 35, 0, −3}/128;

For the 8:3 resampling ratio, each eight input pixels gives three output pixels. Since the sampling points for the output pixels do not all coincide with the input pixels, there are three separate filters that are applied:
{4, 32, 56, 32, 4}/128;
{0, 10, 44, 53, 20, 1}/128;
{1, 20, 53, 44, 10, 0}/128;

For the 9:4 vertical resampling ratio, the filters are designed to account both for interlacing and for the difference between sampling of the luma and chroma. The following table shows the filter taps for the various conditions. As with the 8:3 resampling ratio, the 9:4 resampling ratio also requires multiple filters to account for the different phases of the output pixels relative to the input pixels.

| | Top Field | Bottom Field |
|---|---|---|
| Luma | {2, 32, 60, 32, 2}/128; | {−1, 10, 47, 55, 18, −1}/128; |
| | {0, 22, 58, 43, 6, −1}/128; | {−1, 4, 38, 59, 27, 1}/128; |
| | {−1, 13, 52, 52, 13, −1}/128; | {1, 27, 59, 38, 4, −1}/128; |
| | {−1, 6, 43, 58, 22, 0}/128; | {−1, 18, 55, 47, 10, −1}/128; |
| Chroma | {1, 26, 58, 39, 5, −1}/128; | {−1, 6, 41, 59, 23, 0}/128; |
| | {−1, 16, 55, 48, 11, −1}/128; | {2, 31, 59, 34, 3, −1}/128; |
| | {−1, 9, 46, 55, 19, 0}/128; | {0, 21, 57, 44, 7, −1}/128; |
| | {−1, 4, 36, 60, 28, 1}/128; | {−1, 12, 51, 53, 14, −1}/128; |

In some embodiments, longer-tap filters are able to be used. In some embodiments, to minimize complexity, shorter-tap filters are able to be used. The filters are windowed approximations to the ideal sync interpolator. The bandwidth for the three filters 2:1, 8:3, 9:4 is π/2, 3π/8 and 4π/9, respectively. Bandwidth is defined as the point at which the frequency response drops to ½ its DC value.

FIG. 4 illustrates sampling such that the phase of the right-most column of each macroblock (MB) is preserved which helps to ensure more accurate spatial predictors for intra macroblocks. The left macroblock has red and yellow columns, and the right macroblock is labeled as an “intra-coded macroblock.” Intra-coded macroblocks take horizontal predictions from the right-most column of the left macroblock. For the example in FIG. 4, this means that the intra-coded macroblock would take horizontal predictions from the right-most (yellow) column. At reduced resolution, if the horizontal resampling takes samples at positions 0, 2, 4 and so on, then the prediction pixels for the intra-coded macroblock will be of incorrect phase, as shown in the top-right of FIG. 4. However, if the horizontal resampling takes samples at positions 1, 3, 5 and so on, then the prediction pixels for the intra-coded macroblock will be of correct phase, as shown in the figure's bottom-right. Maintaining correct phase for the pixels needed for spatial prediction in intra-coded macroblocks helps to reduce artifacts.

### Motion Compensation

For the 2:1 horizontal resampling ratio, motion compensation is straightforward. Motion compensation of an M×N block at full resolution is represented at reduced resolution by motion compensation of an M/2×N block. For example, width-16 blocks at full resolution get motion compensated as width-8 blocks at reduced horizontal resolution. It is simplest and fastest (computationally) to use bi-linear interpolation filters for the reduced-resolution motion compensation. Alternatively, higher-quality interpolation is able to be used, such as the six-tap filters defined by the AVC standard or other n-tap filters. The better-quality filters give considerably sharper results, especially when applied to reference frames as in Mode B.

For 8:3 horizontal resolution change, length-16 blocks at full resolution correspond to length-6 blocks at reduced resolution, and length-8 blocks correspond to length-3 blocks. Smaller block widths correspond to fractional numbers of pixels and require smoothing at the block boundaries. For 9:4 vertical resolution change, issues of fractional blocks arise which require considerable care in implementation to avoid artifacts.

### Inverse DCT

Inverse DCT is able to be modified to produce reduced-resolution pixel values. Described herein is a method of combining the AVC inverse transform with a downscaling operation in a single dimension. The two cases of 8:3 and 2:1 downsampling ratios are considered. In both cases, a single vector with eight elements as the AVC-domain input is used, with the output of a single vector of either three or four (depending on the downsampling ratio) pixel-domain output values.

The AVC 8×8 inverse transform is defined in the standard with a sequence of additions and shifts. If the operations are re-written as a single matrix of floating point operations, the result is:

$${H}^{- 1} = [ \begin{matrix}1 & 1.5 & 1 & 1.25 & 1 & 0.75 & 0.5 & 0.375 \\ 1 & 1.25 & 0.5 & - 0.375 & - 1 & - 1.5 & - 1 & - 0.75 \\ 1 & 0.75 & - 0.5 & - 1.5 & - 1 & 0.375 & 1 & 1.25 \\ 1 & 0.375 & - 1 & - 0.75 & 1 & 1.25 & - 0.5 & - 1.5 \\ 1 & - 0.375 & - 1 & 0.75 & 1 & - 1.25 & - 0.5 & 1.5 \\ 1 & - 0.75 & - 0.5 & 1.5 & - 1 & 0.375 & 1 & - 1.25 \\ 1 & - 1.25 & 0.5 & 0.375 & - 1 & 1.5 & - 1 & 0.75 \\ 1 & - 1.5 & 1 & - 1.25 & 1 & - 0.75 & 0.5 & - 0.375\end{matrix} ] \qquad ( 1 )$$

Two cases are considered: downsampling by a ratio of 8:3 (for 1920 to 720) and downsampling by a ratio of 2:1 (for 1440 to 720). For these two ratios, matrices D_{8:3} and D_{2:1} are defined, which are the matrices that operate on the pixel-domain values to produce a down-sampled output. There are many possible ways to design these two matrices. Below are two recommended versions.

$$\begin{matrix}{D}_{8 : 3} = [ \begin{matrix}3 & 3 & 2 & 0 & 0 & 0 & 0 & 0 \\ 0 & 0 & 1 & 3 & 3 & 1 & 0 & 0 \\ 0 & 0 & 0 & 0 & 0 & 2 & 3 & 3\end{matrix} ] \div 8 & ( 2 ) \\ {D}_{2 : 1} = [ \begin{matrix}1 & 1 & 0 & 0 & 0 & 0 & 0 & 0 \\ 0 & 0 & 1 & 1 & 0 & 0 & 0 & 0 \\ 0 & 0 & 0 & 0 & 1 & 1 & 0 & 0 \\ 0 & 0 & 0 & 0 & 0 & 0 & 1 & 1\end{matrix} ] \div 2 & ( 3 )\end{matrix}$$

By concatenating the subsampling matrices with the AVC inverse transform matrix, new transforms are able to be derived that directly operate on the AVC transform coefficients to give downsampled pixel values.

$$\begin{matrix}{{T}_{8 : 3}}^{′} = {D}_{8 : 3} {H}^{- 1} & ( 4 ) \\ = [ \begin{matrix}1 & 1.2188 & 0.437 & 0.046875 & - 0.25 & - 0.1875 & 0.0625 & 0.17188 \\ 1 & 0 & - 0.87 & 0 & 0.05 & 0 & - 0.125 & 0 \\ 1 & - 1.2188 & 0.437 & 0.046875 & - 0.25 & 0.1875 & 0.0625 & - 0.17188\end{matrix} ] & ( 5 ) \\ {{T}_{2 : 1}}^{′ } = {D}_{2 : 1} {H}^{- 1} & ( 6 ) \\ = [ \begin{matrix}1 & 1.375 & 0.75 & 0.437 & 0 & - 0.37 & - 0.25 & - 0.1875 \\ 1 & 0.5625 & - 0.75 & - 1.12 & 0 & 0.812 & 0.25 & - 0.125 \\ 1 & - 0.5625 & - 0.75 & 1.12 & 0 & - 0.812 & 0.25 & 0.125 \\ 1 & - 1.375 & 0.75 & - 0.437 & 0 & 0.37 & - 0.25 & 0.1875\end{matrix} ] & ( 7 )\end{matrix}$$

By incorporating pre-scaling into the inverse quantization process of decoding, the matrices are able to be simplified considerably. The following pre-scaling matrices are defined, whose implementation is incorporated into inverse quantization:

$$\begin{matrix}{P}_{8 : 3} = diag [ \begin{matrix}1 \\ 1.2188 \\ 0.4375 \\ 0.046875 \\ 0.25 \\ 0.1875 \\ 0.0625 \\ 0.17188\end{matrix} ] & ( 8 ) \\ {p}_{2 : 1} = diag [ \begin{matrix}1 \\ 1.375 \\ 0.75 \\ 0.4375 \\ 0 \\ 0.375 \\ 0.25 \\ 0.1875\end{matrix} ] , & ( 9 )\end{matrix}$$

where “diag” represents the matrix formed by placing the given vector along the matrix diagonal.

With these pre-scaling matrices, the final simplified transformation matrix is able to be defined from the transform domain to the downsampled pixel domain:

$$\begin{matrix}{T}_{8 : 3} = [ \begin{matrix}1 & 1 & 1 & - 1 & - 1 & - 1 & 1 & 1 \\ 1 & 0 & - 2 & 0 & 2 & 0 & - 2 & 0 \\ 1 & - 1 & 1 & 1 & - 1 & 1 & 1 & - 1\end{matrix} ] , & ( 10 ) \\ {T}_{2 : 1} = [ \begin{matrix}1 & 1 & 1 & 1 & 0 & - 1 & - 1 & - 1 \\ 1 & 0.40909 & - 1 & - 2.5714 & 0 & 2.1667 & 1 & - 0.66667 \\ 1 & - 0.40909 & - 1 & 2.5714 & 0 & - 2.1667 & 1 & 0.66667 \\ 1 & - 1 & 1 & - 1 & 0 & 1 & - 1 & 1\end{matrix} ] , & ( 11 )\end{matrix}$$

The transformation for the 8:3 ratio is able to be implemented with several additions and one left-shift, while the transformation for the 2:1 ratio requires several additions and four multiplications. Variations that explicitly zero higher-frequency coefficients are possible, resulting in slightly more smoothing and possibly reducing complexity by a small margin.

Similar analysis is able to be performed for the case of the 4×4 AVC inverse transform. Vectors and matrices of length eight are able to be considered by simultaneously considering two length-four vectors. The relevant matrices are listed below. Notation is re-used from the 8×8 derivations with the understanding that the matrices here are applicable to the 4×4 cases.

The final transform is

$$\begin{matrix}{T}_{8 : 3} = [ \begin{matrix}2 & 1 & - 1 & 1 & 0 & 0 & 0 & 0 \\ 1 & - 1 & 1 & - 1 & 1 & 1 & 1 & 1 \\ 0 & 0 & 0 & 0 & 2 & - 1 & - 1 & - 1\end{matrix} ] , & ( 12 ) \\ {T}_{2 : 1} = [ \begin{matrix}1 & 1 & 0 & - 1 & 0 & 0 & 0 & 0 \\ 1 & - 1 & 0 & 1 & 0 & 0 & 0 & 0 \\ 0 & 0 & 0 & 0 & 1 & 1 & 0 & - 1 \\ 0 & 0 & 0 & 0 & 1 & - 1 & 0 & 1\end{matrix} ] , & ( 13 )\end{matrix}$$

where the AVC inverse 4×4 transform (applied to a length-eight vector) is

$${H}^{- 1} = [ \begin{matrix}1 & 1 & 1 & 0.5 & 0 & 0 & 0 & 0 \\ 1 & 0.5 & - 1 & - 1 & 0 & 0 & 0 & 0 \\ 1 & 0.5 & - 1 & 1 & 0 & 0 & 0 & 0 \\ 1 & - 1 & 1 & - 0.5 & 0 & 0 & 0 & 0 \\ 0 & 0 & 0 & 0 & 1 & 1 & 1 & 0.5 \\ 0 & 0 & 0 & 0 & 1 & 0.5 & - 1 & - 1 \\ 0 & 0 & 0 & 0 & 1 & - 0.5 & - 1 & 1 \\ 0 & 0 & 0 & 0 & 1 & - 1 & 1 & - 0.5\end{matrix} ] , \qquad ( 14 )$$

and the pre-scaling matrices are

$$\begin{matrix}{P}_{8 : 3} = diag [ \begin{matrix}0.5 \\ 0.4375 \\ 0.25 \\ 0.0625 \\ 0.5 \\ 0.4375 \\ 0.25 \\ 0.0625\end{matrix} ] & ( 15 ) \\ {P}_{2 : 1} = diag [ \begin{matrix}1 \\ 0.75 \\ 0 \\ 0.25 \\ 1 \\ 0.75 \\ 0 \\ 0.25\end{matrix} ] & ( 16 )\end{matrix}$$

The transformations for both the 8:3 ratio and the 2:1 ratio are able to be implemented with very few operations.

In the analysis that follows, the cost of right or left bit shifts is not included. To implement D_{8:3} by itself, at most 11 additions are required. To implement D_{2:1}, 4 additions are required. There are three stages in the implementation of the AVC length-eight inverse transform, with a total of 28 additions required. There are a total of 16 additions required to perform the two length-four inverse transforms. To implement T_{8:3} for the length-8 case requires 9 additions. To implement T_{2:1} for the length-8 case requires 13 additions and 4 multiplications. To implement T_{8:3} for the length-4 case requires 9 additions. To implement T_{2:1} for the length-4 case requires 6 additions.

The 2:1 downsampling filter introduces a half-pixel phase shift in the filtered outputs which has two primary implications. For the case of 4:2:0 YcbCr color subsampling, if the same downsampling filter is used for both luma and chroma, then the luma and chroma will have a phase shift of a quarter pixel relative to each other (in units of luma at the downsampled resolution). This phase shift contributes to error drift if these downsampled pictures are used as reference pictures. If a different downsampling filter is used for some or all reference pictures, then the phase of the other filter should be matched to the downsampling filter described herein.

Due to the non-integer subsampling ratio and the different rows that compose D_{8:3}, the phase for the 8:3 downsampling filter is difficult to describe. The phase shift in the filtered outputs has the following implications. For the case of 4:2:0 YcbCr color subsampling, if the same downsampling filter is used for both luma and chroma, a phase shift of approximately ⅓ of a pixel between luma and chroma (in units of luma at the downsampled resolution) is introduced. This phase shift contributes to error drift if these downsampled pictures are used as reference pictures. The uneven spacing between output pixels also contributes to error drift if the downsampled pictures are used as reference. If a different downsampling filter is used for some or all reference pictures, then the phase of the other filter should be matched to the downsampling filter described herein.

Benefits of this Inverse DCT include the consideration of both the length-four and the length-eight inverse transforms from the H.264 standard. The composite transform is implemented using fast factorizations. Pre-scaling factors are incorporated into the dequantization process, thus minimizing the number of multiplications.

### Intra Macroblocks

When an intra-coded macroblock is encountered during reduced-resolution decoding, it is decoded at full resolution. To decode an intra-coded macroblock at full resolution, spatial prediction pixels at full resolution are accessed. In general there are three cases possible:

1. If any of the neighboring macroblocks are also intra-coded, then it is able to be assumed that they have already been decoded at full resolution. Therefore, the spatial predictors from those other intra-coded macroblocks are already available.

2. If the full resolution reference pictures are available, then the macroblocks used as spatial predictors are able to be decoded at full resolution. This is possible in Modes A and C because reference pictures are not decoded at reduced resolution. This is sometimes possible in Mode B, but only when the reference picture is an I-picture. Decoding these macroblocks at full resolution decreases the complexity benefit derived from the reduced resolution decoding algorithm.

3. In the worst-case scenario, the reduced resolution pixels are interpolated back to full resolution, so that those pixels are able to be used as spatial predictors for the intra-coded macroblock. This is often used in Mode B.

After decoding a macroblock at full resolution according to any of the above three cases, the spatial-domain downsampling filters discussed above are able to be used to go to reduced resolution.

### Complexity Reduction

Complexity benefits of reduced-resolution decoding are primarily intended for the motion compensation module, discussed in the subsections below for the two cases of horizontal and vertical down-decoding. Complexity analysis of the reduced-resolution IDCT, for the cases of 2:1 and 8:3 resampling ratios, is discussed herein.

### Horizontal Down-Decoding

For 2:1 horizontal down-decoding, the theoretic number of arithmetic operations for motion compensation is approximately ½ that of motion compensation at full resolution. Similarly, for 8:3 horizontal down-decoding, there is roughly ⅜ complexity for motion compensation.

### Vertical Down-Decoding

If the ratio of input lines to output lines is G:H (G>=H), then reduced-resolution motion compensation in the vertical dimension only processes a fraction H/G of the number of lines needed for full resolution motion compensation. This results in complexity gains for motion compensation of approximately G/H. Although 2:1 and 8:3 ratios have been described mainly for the horizontal direction, they are able to be used for the vertical direction.

As an example, the input is 1080i and the output is 480i. In such a case, the ratio G:H is 9:4, and the complexity is reduced by more than a factor of two for motion compensation.

As another example, the input is 1080i and the output is 480p. In such a case, the ratio G:H is 9:8, (540 lines in a 1080i field, and 480 lines in a 480p frame) and complexity is not changed by much with vertical down-decoding.

### MPEG-2 Encoder

Although the AVC decoder has been described herein, the MPEG-2 encoder is discussed as well. The approach is to generate MPEG-2 motion vector candidates from the AVC motion vectors. Sum of Absolute Differences (SADs) are able to be evaluated for a number of these candidates, and the best motion vector is able to be chosen according to a minimum SAD. Depending on computational constraints, the number of candidates is able to be increased or decreased.

Some important factors to be considered include the following.

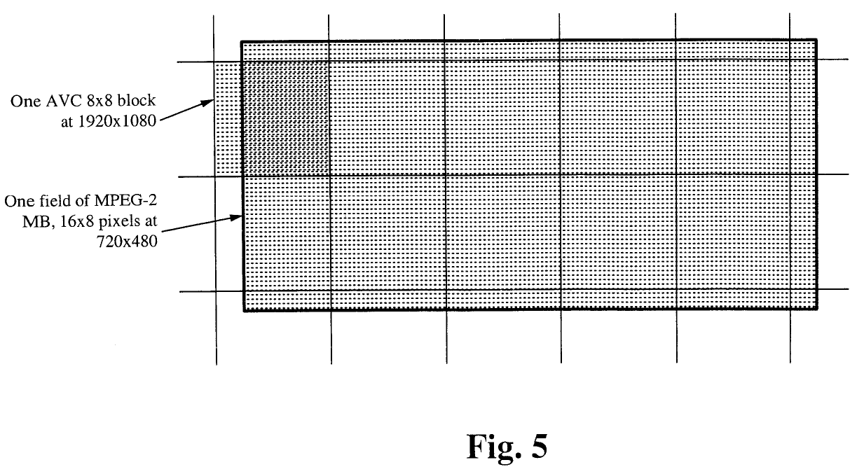

When transcoding from HD to SD, there are many more AVC candidates than when transcoding between equivalent resolutions. FIG. 5 illustrates how there are many AVC blocks that contribute to a single MPEG-2 macroblock. It is important to reduce the large number of motion and mode candidates to a short list to avoid too many SAD evaluations.

If the MPEG-2 video is to be 30 P but the input is interlaced, then additional steps are taken. Since the original AVC data is interlaced, each field references another field. If only one AVC field is encoded as an MPEG-2 frame, then many of the candidate predictions at the MPEG-2 encoder will be for a reference field that does not exist.

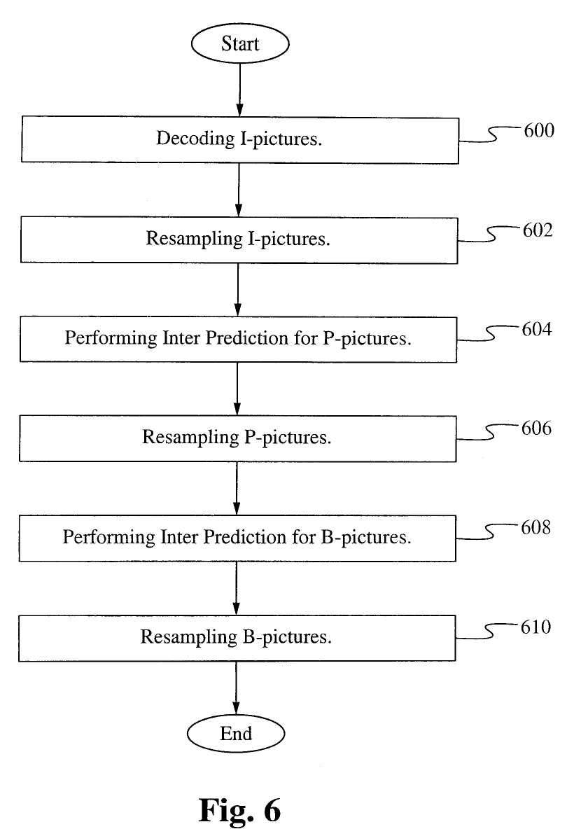

FIG. 6 illustrates a flowchart of a process of decoding video for transcoding or display at a lower resolution. In the step 600, I-pictures are decoded. In some embodiments, the I-pictures are decoded at full resolution. In the step 602, the I-pictures are resampled horizontally and then vertically. In the step 604, inter prediction is performed for P-pictures. In some embodiments, the P-pictures are at full resolution. In some embodiments, the P-pictures are at reduced horizontal resolution. In the step 606, the P-pictures are resampled. In some embodiments, the P-pictures are resampled horizontally and vertically. In some embodiments, the P-pictures are resampled vertically only. In the step 608, inter prediction for B-pictures is performed. In some embodiments, inter prediction for the B-pictures is performed at reduced horizontal resolution. In some embodiments, inter prediction for the B-pictures is performed at reduced horizontal resolution and reduced vertical resolution. In some embodiments, in the step 610, the B-pictures are resampled vertically. In some embodiments, the step 610 is skipped. In some embodiments, a correct phase is maintained for the pixels needed for spatial prediction in intra-coded macroblocks. In some embodiments, motion compensation is implemented at reduced resolution. In some embodiments, a modified inverse discrete transform (IDCT) is implemented to produce reduced-resolution pixel values. In some embodiments, pre-scaling during inverse quantization is implemented to reduce the complexity. In some embodiments, an intra-coded macroblock is decoded using spatial prediction pixels at full resolution. Ultimately, a decoded video is output.

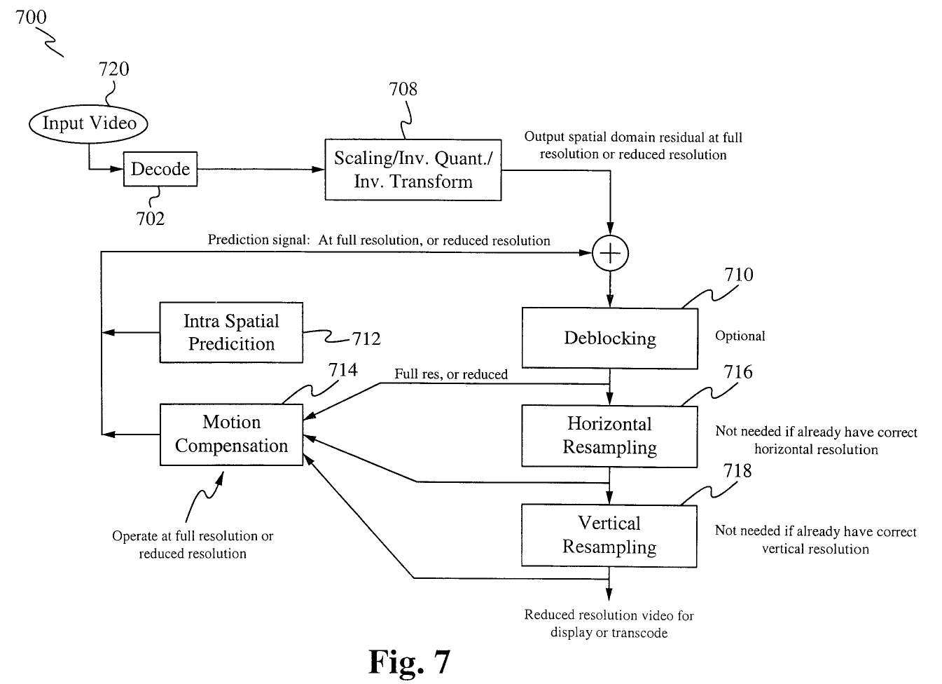

FIG. 7 illustrates a block diagram of a decoder 700 to implement the reduced-resolution decoding described herein. The decoder 700 includes a combination of temporal and spatial predictions along with transform coding. An input video 720 is received and specified aspects of the video are decoded by a decoding module 702 with the output of the decoding module 702 going to a scaling/inverse quantization/inverse transform module 708. The scaling/inverse quantization/inverse transform module 708 outputs a spatial domain residual at full resolution or reduced resolution.

The first picture of a sequence is usually “intra” coded using only information contained within itself. Each part of a block in an intra frame is then predicted at the intra prediction module 712 using spatially neighboring samples of previously coded blocks. The decoding process chooses which neighboring samples are utilized for intra prediction and how they are used. For the rest of the pictures of a sequence, typically “inter” coding is used. Inter coding implements motion compensation 714 from other previously decoded pictures. The motion data is transmitted as side information which is used by the decoder 700. The intra prediction module 712 and the motion compensation 714 produce a prediction signal which is able to be at full resolution or reduced resolution. The prediction signal is added with the output of the scaling/inverse quantization/inverse transform module 708.

A deblocking filter 710 is implemented to control the strength of the filtering to reduce the blockiness of the image. In some embodiments, the blocking filter is optional.

A horizontal resampling component 716 and a vertical resampling component are also included to perform the resampling as described above. Horizontal resampling and vertical resampling are only performed when needed (e.g. incorrect resolution). The output of the deblocking filter 710, the horizontal resampling component 716 and the vertical resampling component 718 also go to the motion compensation 714 in full or reduced resolution. The result of the decoder 700 is a reduced resolution video for display or transcode.

For conciseness, other components of the decoder 700 have not been illustrated. One skilled in the art is able to readily appreciate additional or fewer components within the decoder 700.

The methods and systems described herein are able to be implemented on or within any suitable computing device. Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a television, a home entertainment system or any other suitable computing device.

To utilize the reduced-resolution decoding method, a computing device operates as usual, but the video processing is modified so that the video resolution is reduced as desired. The utilization of the computing device from the user's perspective is similar or the same as one that uses a standard operation. For example, the user still simply turns on a television to watch. Then, when the user decides to view picture-in-picture, the user clicks the appropriate button on the remote control. The picture-in-picture appears with slightly reduced resolution. The reduced-resolution decoding method is able to automatically reduce the resolution of the video without user intervention. The reduced-resolution decoding method is able to be used anywhere that reduced-resolution decoding is beneficial. Many applications are able to utilize the reduced-resolution decoding method including, but not limited to, transcoding from high-definition to standard-definition, high-resolution AVC video for display at lower resolutions, such as picture-in-picture on a television or display of recorded AVC content from a camcorder on the camcorder's low-resolution display.

In operation, the reduced-resolution decoding method improves the efficiency and reduces the complexity of reduced-resolution decoding. Efficiency is improved by directly decoding parts of the video sequence at reduced resolution. The cost of resampling is also reduced using the reduced-resolution decoding method. By implementing a modified version of Inverse DCT, reduced-resolution pixel values are able to be generated. By modifying the AVC transforms, complexity is further reduced. Prescaling is able to be implemented in the inverse quantization process of decoding which further simplifies the process. These improvements and others allow the reduced-resolution decoding process to be implemented very efficiently.

Although specific coefficients for the resampling filters have been described above, more complicated coefficients are able to be derived with better quality and simpler coefficients with lower quality.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of decoding Advanced Video Coding video at a reduced resolution using a computing device comprising:
a. decoding I-pictures at full resolution;
b. resampling the I-pictures horizontally and vertically;
c. performing inter prediction for P-pictures at full resolution;
d. resampling the P-pictures horizontally and vertically;
e. performing inter prediction for B-pictures at reduced horizontal resolution;
f. resampling the B-pictures vertically; and
g. outputting a reduced-resolution video.

2. The method of claim 1 wherein the resampling implements a resampling ratio selected from the group consisting of 2:1, 8:3 and 9:4.

3. The method of claim 2 wherein a linear phase filter is used for 2:1 horizontal resampling.

4. The method of claim 2 wherein three separate filters are used for 8:3 horizontal resampling.

5. The method of claim 2 wherein a set of long-tap filters is used for 9:4 vertical resampling.

6. The method of claim 2 wherein a set of short-tap filters is used for 9:4 vertical resampling.

7. The method of claim 2 wherein filters implementing the resampling ratios of 2:1, 8:3 and 9:4 have bandwidths of π/2, 3π/8 and 4π/9, respectively.

8. The method of claim 1 further comprising resampling that maintains a phase that preserves right-most columns of macroblocks.

9. The method of claim 1 further comprising implementing motion compensation at reduced resolution.

10. The method of claim 9 wherein implementing motion compensation uses bi-linear interpolation filters.

11. The method of claim 9 wherein implementing motion compensation uses plurality-tap filters.

12. The method of claim 1 further comprising implementing a modified inverse discrete cosine transform to produce reduced-resolution pixel values.

13. The method of claim 1 further comprising pre-scaling during inverse quantization.

14. The method of claim 1 further comprising decoding an intra-coded macroblock using spatial prediction pixels at full resolution.

15. The method of claim 1 further comprising receiving a first video to be decoded.

16. The method of claim 15 wherein the first video is high definition and the reduced-resolution video is standard definition.

17. A system for decoding Advanced Video Coding video at a reduced resolution using a computing device comprising:
a. a decoding module for decoding I-pictures at full resolution;
b. a resampling module operatively coupled to the decoding module, the resampling module configured for resampling the I-pictures, P-pictures and B-pictures; and
c. an inter prediction module operatively coupled to the resampling module, the inter prediction module configured for performing inter prediction for the P-pictures and the B-pictures, resulting in a reduced-resolution decoded video.

18. The system of claim 17 wherein the resampling module implements a resampling ratio selected from the group consisting of 2:1, 8:3 and 9:4.

19. The system of claim 18 wherein a linear phase filter is used for 2:1 horizontal resampling.

20. The system of claim 18 wherein three separate filters are used for 8:3 horizontal resampling.

21. The system of claim 18 wherein a set of long-tap filters is used for 9:4 vertical resampling.

22. The system of claim 18 wherein a set of short-tap filters is used for 9:4 vertical resampling.

23. The system of claim 18 wherein filters implementing the resampling ratios of 2:1, 8:3 and 9:4 have bandwidths of π/2, 3π/8 and 4π/9, respectively.

24. The system of claim 17 further comprising a motion compensation module configured for implementing motion compensation at reduced resolution.

25. The system of claim 24 wherein the motion compensation module uses bi-linear interpolation filters.

26. The system of claim 24 wherein the motion compensation module uses plurality-tap filters.

27. The system of claim 17 further comprising a modified inverse discrete cosine transform module to produce reduced-resolution pixel values.

28. The system of claim 17 further comprising pre-scaling during inverse quantization.

29. The system of claim 17 further comprising an intra prediction module for decoding an intra-coded macroblock using spatial prediction pixels at full resolution.

30. The system of claim 17 wherein a first video is received to be decoded.

31. The system of claim 30 wherein the first video is high definition and the reduced-resolution decoded video is standard definition.

32. A method of decoding Advanced Video Coding video at a reduced resolution using a computing device comprising:
a. decoding I-pictures at full resolution;
b. resampling the I-pictures horizontally and vertically;
c. performing inter prediction for P-pictures at reduced horizontal resolution;
d. resampling the P-pictures vertically;
e. performing inter prediction for B-pictures at reduced horizontal resolution;
f. resampling the B-pictures vertically; and
g. outputting a reduced-resolution video.

33. A method of decoding Advanced Video Coding video at a reduced resolution using a computing device comprising:
a. decoding I-pictures at full resolution;
b. resampling the I-pictures horizontally and vertically;
c. performing inter prediction for P-pictures at full resolution;
d. resampling the P-pictures horizontally and vertically;
e. performing inter prediction for B-pictures at reduced horizontal resolution and reduced vertical resolution; and
f. outputting a reduced-resolution video.
